(19) United States
(12) Patent Application Publication
(10) Pub. No.: US 2025/0147593 A1
(43) Pub. Date: May 8, 2025

(54) SYSTEMS AND METHODS FOR INTEGRATING KINAESTHETIC COMMUNICATION IN A TRANSACTION CARD

(71) Applicant: Capital One Services, LLC, McLean, VA (US)

(72) Inventors: Bryant YEE, Silver Spring, MD (US); Tyler MAIMAN, Melville, NY (US); Kevin OSBORN, Newton Highlands, MA (US)

(73) Assignee: Capital One Services, LLC, McLean, VA (US)

(21) Appl. No.: 18/502,838

(22) Filed: Nov. 6, 2023

(51) Int. Cl. G06F 3/01; G06F 3/044; G06K 19/07

(52) U.S. Cl. CPC G06F 3/016; G06F 3/044; G06K 19/0718; G06K 19/0723

(57) ABSTRACT

Disclosed is a transaction card may include a card body comprising a top surface and a bottom surface opposite the top surface, a chip secured to the top surface of the card body and configured to communicate wirelessly; a feedback element secured to the card body and including one or more tactile elements and a feedback sensor; and a feedback processor in communication with the chip and the feedback element. The feedback processor may, in response to receiving a signal from the feedback sensor indicative of the presence of a thumb or finger of a user on the feedback element and in response to receiving a signal from the chip, drive one or more of the one or more tactile elements to generate tactile feedback for the user.

### TECHNICAL FIELD

Various embodiments of the present disclosure relate generally to payment or other transaction cards and, more particularly, to transaction cards having a feedback element including one or more tactile elements to generate tactile feedback for a cardholder.

### BACKGROUND

Transaction cards, such as credit and debit cards, have become a primary means for customers to conduct financial transactions. While transaction cards may be convenient for many users, they may present some difficulties for users who experience vision or hearing impairments. For example, the orientation of the card is important when inserting a chip into a reader or swiping a magnetic strip to complete a transaction. It may be difficult or even impossible for certain individuals to properly orient a transaction card to perform these functions. This is especially true in cards having non-raised printed information as opposed to raised printed information (e.g., printed cardholder information providing tactile indication of orientation).

In view of these and other deficiencies in existing techniques, solutions are needed for helping a holder of a card orient the card properly and convey information to the holder that a transaction was completed. The present disclosure is directed to overcoming one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, payment, transaction, or other cards having a feedback element including one or more tactile elements to generate tactile feedback and related methods are disclosed. The disclosed cards may provide a card holder with a tactile indication that the transaction card is oriented in a proper manner to complete a transaction and/or that a transaction has been completed.

For instance, a transaction card may include a card body comprising a top surface and a bottom surface opposite the top surface, a chip secured to the top surface of the card body and configured to communicate wirelessly; a feedback element secured to the card body and including one or more tactile elements and a feedback sensor; and a feedback processor in communication with the chip and the feedback element. The feedback processor may, in response to receiving a signal from the feedback sensor indicative of the presence of a thumb or finger of a user on the feedback element and in response to receiving a signal from the chip, drive one or more of the one or more tactile elements to generate tactile feedback for the user.

A method may include receiving, at a feedback processor, a signal indicative of the presence of a thumb or finger of a user on a feedback sensor of a feedback element positioned on a transaction card; and transmitting, from the feedback processor, a signal to actuate one or more tactile elements of the feedback element to indicate to the user that the thumb or finger is in contact with the feedback element. The method may further include receiving, at the feedback processor, a signal indicative of the presence of a merchant device proximate to the transaction card; and transmitting, from the feedback processor, a signal to actuate one or more tactile elements of the feedback element to indicate to the user that the merchant device is proximate to the transaction card.

According to some embodiments of the disclosure, a card may include a card body; a feedback element secured to the card body and including one or more tactile elements and a feedback sensor; and a feedback processor in communication with the feedback element. The feedback processor, in response to receiving a signal from the feedback sensor, may drive one or more of the one or more tactile elements to generate a vibratory tactile feedback indicating to a user an orientation of the transaction card.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A depicts a top surface of an exemplary transaction card, according to one or more embodiments of the present disclosure.

FIG. 1B depicts a bottom surface of an exemplary transaction card, according to one or more embodiments of the present disclosure.

FIG. 2 is a block diagram of an exemplary card with integrated feedback components, according to one or more embodiments.

FIG. 3 is a flowchart depicting an exemplary method for providing tactile feedback to a user of the transaction card.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In general, the present disclosure is directed to payment, transaction, or other cards and, more particularly, to cards having tactile feedback for a user. As discussed above, while transaction cards may be convenient for many users, they may present some difficulties for users with hearing or vision impairments. For example, the orientation of the card is important when inserting a chip into a reader or swiping a magnetic strip to complete a transaction. It may be difficult or even impossible for certain individuals to properly orient a transaction card to perform these functions.

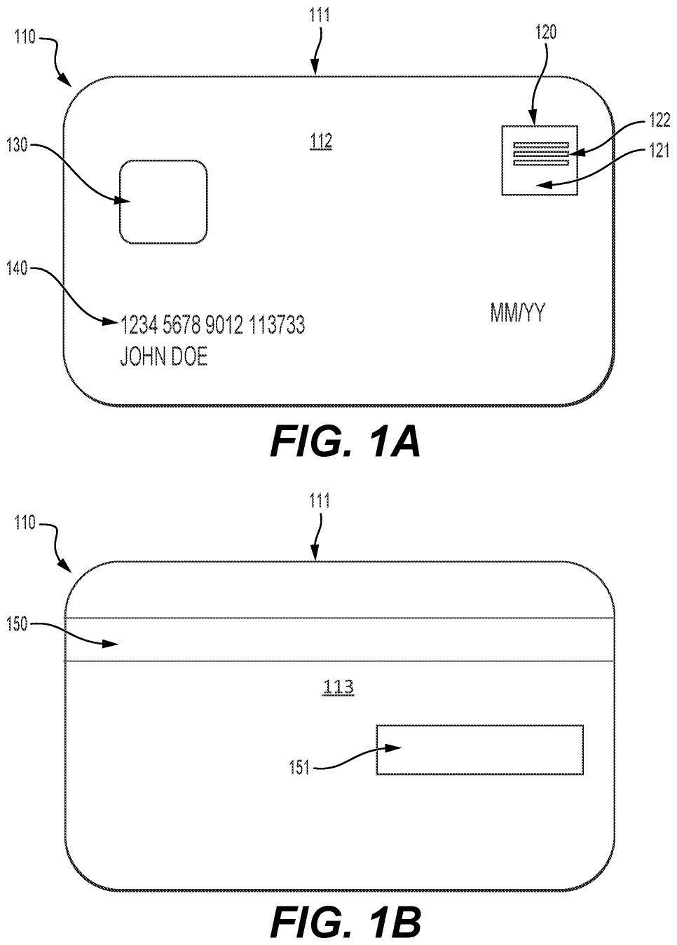

FIGS. 1A and 1B depict an exemplary transaction card 110, consistent with one or more embodiments of the present disclosure. Transaction card 110 may be any physical card product configured to store information, such as financial information (e.g., card numbers, account numbers, etc.), quasi-financial information (e.g., rewards balance, discount information, etc.), information pertaining to a transaction (e.g., transaction status, transaction amount, etc.) and/or individual-identifying information (e.g., name, address, etc.). Examples of transaction cards include, but are not limited to, credit cards, debit cards, gift cards, rewards cards, frequent flyer cards, merchant-specific cards, rewards cards, travel cards (e.g., a train pass, a bus pass, etc.), discount cards, insurance cards, identification cards, and driver's licenses. Accordingly, the term “transaction” should be construed broadly to include any presentation or transfer of information associated with the transaction card.

FIG. 1A shows a top view of transaction card 110 consistent with one or more of the disclosed embodiments. The transaction card 110 includes a card body 111 with a top surface 112. As shown, disposed on the top surface 112 of the transaction card 110 may be an electronic feedback element 120 that may include a feedback sensor 121 and one or more tactile elements 122, a Europay, Mastercard, and Visa (EMV) chip 130 secured thereto and configured to communicate wirelessly, and cardholder information 140. Examples of cardholder information 140 may include transaction information such as cardholder names, card verification values (CVVs), card expiration dates, personal identification numbers (PINs), all or portions of a card identification number, or any combination thereof. The feedback sensor 121 may be any type of sensor sensitive to touch, such as a resistive feedback sensor or a capacitive feedback sensor. The one or more tactile elements may include any type of elements that are capable of being moved to produce a tactile response. For example, the one or more tactile elements 122 may be integrated linear resonant actuators (LRAs) that move a mass in a reciprocal manner by means of a magnetic coil. In another embodiment, the one or more tactile elements may be piezoelectric elements. Details regarding the operations of integrated linear resonant actuators (LRAs) and piezoelectric elements can be found in U.S. Pat. No. 10,878,302 (which is hereby incorporated by reference).

FIG. 1B shows a bottom view of transaction card 110 consistent with one or more of the disclosed embodiments. The card body 111 of transaction card 110 includes a bottom surface 113 opposite the top surface 112. Disposed on the bottom surface 113 of the transaction card 110 may be a magnetic strip 150, a signature block 151, an imprinted name and/or account number, an expiration date, a card verification value (CVV) code, a Quick Response (QR) code, or various other card features. In some embodiments, cardholder information 140 may be disposed on the bottom surface 113 of transaction card 110 instead of and/or in addition to the top surface 112 of the card.

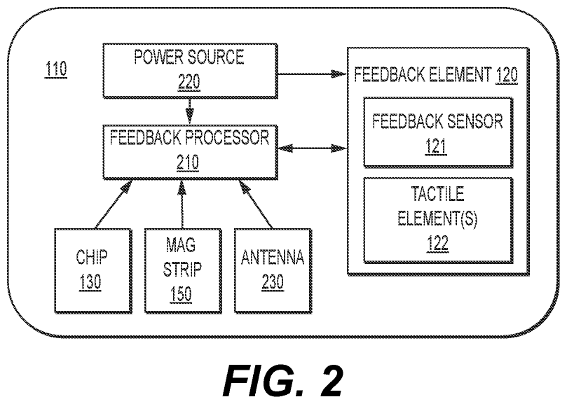

FIG. 2 is a block diagram of an example transaction card 110 with an integrated feedback device consistent with disclosed embodiments. As noted above, transaction card 110 may comprise electronic feedback element 120, an EMV chip 130, and magnetic strip 150. Additionally, transaction card 110 may comprise a feedback processor 210, a power source 220 embedded therein, and an antenna 230. Further, as shown in FIG. 2, feedback element 120 may include feedback sensor 121 and one or more tactile elements 122. Although not depicted, it is understood that transaction card 110 may comprise electrical connections between the various components. It should be appreciated, however, that transaction card 110 may include additional and/or alternative components than those shown in FIG. 2. It is understood that one or more of the described components may comprise multiple components or subcomponents. Further, it is understood that in some instances, one or more of the described components may be combined into a single component (e.g., a chip, module, etc.).

Feedback processor (or processors) 210 may be any processing device configured to generate and transmit operation signals to electronic feedback element 120. Processor 210 may comprise a computer, a microprocessor, a processing unit, an integrated circuit, an application specific integrated circuit (ASIC), or the like.

Power source 220 may be any energy storage device configured to supply power to components of transaction card 110. For example, power source 220 may supply power to processor 210, electronic feedback element 120, and EMV chip 130. In some embodiments, power source 220 may be a battery (e.g., a rechargeable lithium-ion battery, an alkaline battery, a nickel-metal hydride battery, a lead-acid battery, etc.). Power source 220 may comprise various other forms of energy storage devices, including a capacitor, a supercapacitor, or the like.

Feedback processor 210 may be configured to drive one or more of the tactile elements 122 to generate feedback for a user in response to signals received from the feedback sensor 121, the EMV chip 130, the magnetic strip 150, or the antenna 230. The one or more tactile elements 122 may be integrated linear resonant actuators (LRAs) that move a mass in a reciprocal manner by means of a magnetic coil, as discussed above. Alternatively or additionally, the one or more tactile elements 122 may be piezoelectric actuators. When the one or more tactile elements 122 are actuated, they produce a tactile response for the user that may take the form of oscillatory or vibratory motion that may be felt and/or heard by the user.

In some embodiments, the feedback processor 210 drives one or more of the tactile elements 122 to generate feedback for a user in response to receiving a signal from the feedback sensor 121 that a thumb or finger is in contact with the feedback sensor 121. In these embodiments, a user may place one or more of their thumbs or fingers on the card surfaces to identify the position of feedback sensor 121. As shown in FIG. 1A, feedback sensor 121 and the one or more tactile elements 122 are substantially coincident on the top surface 112 of transaction card 110. The one or more tactile elements 122 may be flush with the top surface of the card body or may include one or more protrusions to help identify their position on the card body.

In these embodiments, when a user's thumb or finger comes in contact with the feedback sensor 121, a signal is transmitted to processor 210 indicating the contact. This may be done with the use of a resistive feedback sensor, a capacitive feedback sensor, or the like. When feedback processor 210 receives the signal from the feedback sensor 121 indicative of the presence of the thumb or finger, it drives at least one of the one or more tactile elements 122 to generate tactile feedback for the user. As the feedback sensor 121 and tactile elements are coincident on the top surface 112 of card body 111, a user may receive the tactile feedback at a location of the feedback sensor 121, indicating to the user the orientation of the transaction card 110, e.g., which surface is the top surface and which surface is the bottom surface 112, and which direction is left or right based on the position of the feedback sensor 121 and receipt of the feedback associated with the feedback sensor.

In some embodiments, the feedback processor 210 may drive one or more of the tactile elements 122 to generate feedback for a user in response to receiving a signal from the EMV chip 130. In an exemplary embodiment, the signal received form EMV chip may be indicative of a successful transaction at a merchant device. The user may place a thumb or finger on the feedback sensor 121 and receive a signal indicating the orientation of the card, as described above. Once the user is aware of the orientation, they may then have an understanding of the position of the EMV chip, and thus correctly enter the transaction card 110 into the merchant device with the EMV chip 130 oriented in the proper manner. Upon a completion of the transaction, the EMV chip 130 may send a signal to the feedback processor 210, which drives one or more of the tactile elements 122 in response to generate feedback for the user indicating a successful transaction. When the transaction card 110 is inserted in a merchant device, it may also draw power from the merchant device to power the feedback processor 210 and tactile elements 122, in addition to or instead of from the power source 220.

In other embodiments, the feedback processor 210 may drive one or more of the tactile elements 122 to generate feedback for a user in response to receiving a signal from the magnetic strip 150 in a manner similar to that of the EMV chip 130. The user may place a thumb or finger on the feedback sensor 121 and receive a signal indicating the orientation of the card, as described above. Once the user is aware of the orientation, they may then have an understanding of the position of the magnetic strip 150, and thus correctly enter the transaction card 110 into the merchant device with the magnetic strip 150 oriented in the proper manner. Upon a completion of the transaction, the feedback processor 210 may receive a signal indicative of a successful transaction from the merchant device, which drives one or more of the tactile elements 122 in response to generate feedback for the user indicating a successful transaction.

In yet another embodiment, the feedback processor 210 may drive one or more of the tactile elements 122 to generate feedback for a user in response to receiving a signal from the antenna 230. The signal received from the antenna 230 may be indicative of proximity to a merchant device, and/or it may be indicative of a successful transaction performed at a merchant device. In this manner, a user may identify the location of the merchant device using the antenna 230 of the transaction card 110. The user may place a thumb or finger on the feedback sensor 121 and receive a signal indicating the orientation of the card, as described above. The user can then place the card 110 in a position near where they expect the merchant device to be, and upon positioning the card 110 in proximity to the merchant device, receive tactile feedback to confirm the proximity. If a transaction has been initiated, this may also complete the transaction.

In some embodiments, the feedback processor 210 may be configured to drive the one or more tactile elements 122 to provide different tactile feedback in response to different signals received at the feedback processor. In one exemplary embodiment, the feedback processor 210 may be configured to drive the one or more tactile elements 122 to provide a single pulse in response to a signal indicating that the user has placed a thumb or finger on the feedback sensor 121, and may be configured to provide two pulses (for example) in response to a signal indicating proximity to a merchant device. In the same or different exemplary embodiment, the feedback processor 210 may further be configured to drive the one or more tactile elements 122 to provide a set of three pulses (for example) in response to a signal from the merchant device indicating a successful transaction, and/or a set of four pulses (for example) in response to a signal from the merchant device indicating an unsuccessful or declined transaction.

In some embodiments, the feedback may be differentiated based on the lengths of the pulses rather than the number of pulses. For example, one short pulse may be used to indicate the presence of a thumb or finger on the feedback sensor 121, and one long pulse may be used to indicate proximity to a merchant device. In yet other embodiments, the lengths of pulses and the number of pulses may be used in tandem to communicate feedback to the user, e.g., two short pulses or one long pulse followed by a short pulse. In some embodiments, the pulses may increase in length, number, or magnitude as the card 110 approaches the merchant device. Magnitude may be a measure of the intensity of the pulse.

It is noted that the above mentioned embodiments are not mutually exclusive and may be combined in any manner. For example, the feedback processor 210 may be configured to drive one or more of the tactile elements 122 in response to signals from a combination of one or more of the feedback sensor 121, EMV chip 130, magnetic strip 150, and antenna 230 without departing from the scope of the invention.

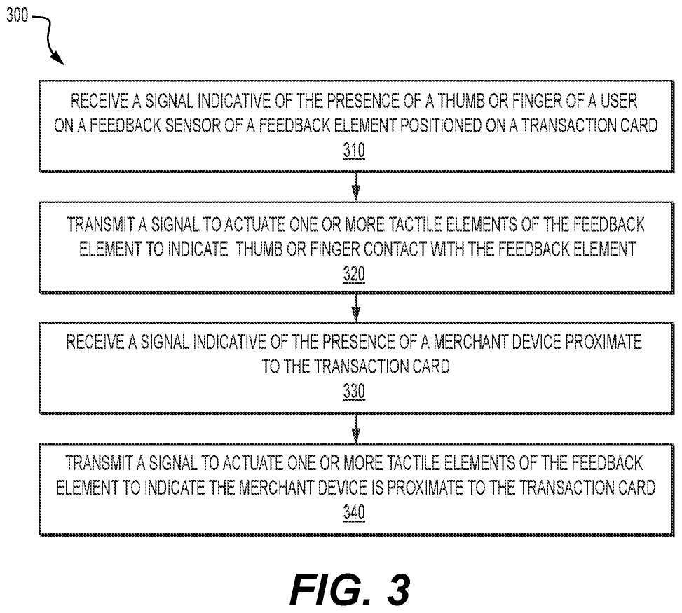

FIG. 3 depicts a flowchart of an exemplary method 300 of generating tactile feedback for a user of a transaction card 110. At step 310, the feedback processor 210 receives a signal indicative of the presence of a thumb or finger of a user on a feedback sensor 121 of a feedback element 120 positioned on the transaction card 110. The feedback sensor 121 may be, for example, a resistive feedback sensor, such that the pressure applied by a thumb or finger upon the feedback sensor creates a signal at the feedback sensor 121 that is transmitted to the feedback processor 210. The feedback sensor may alternatively be, for example, a capacitive feedback sensor, such that the presence of a conductive object such as the thumb or finger of a user upon the feedback sensor creates a signal at the feedback sensor 121 that is transmitted to the feedback processor 210.

At step 320, upon receipt of the signal from the feedback sensor 121, the feedback processor 210 transmits a signal to drive or actuate one or more tactile elements 122 of feedback element 120 to indicate to the user that the thumb or finger is in contact with the feedback element 120. The one or more tactile elements 122 may be integrated linear resonant actuators (LRAs) that move a mass in a reciprocal manner by means of a magnetic coil, as discussed above. Alternatively or additionally, the one or more tactile elements 122 may be piezoelectric actuators. When the one or more tactile elements 122 are actuated, they produce a tactile response for the user that may take the form of oscillatory or vibratory motion. The one or more tactile elements 122 may be flush with the top of the transaction card 110, or they may protrude from the top of the transaction card 110, or they may be set lower than the top of the transaction card 110, such that they are in a groove relative to the remainder of the card. They may be set flush with the top of the card 110 for aesthetic and functional purposes, such as to prevent the transaction card 110 from snagging on objects, for example, when being removed or inserted into a user's wallet or pocket. Alternatively, the one or more tactile elements may protrude from or may be inset from the top of the transaction card 110 to be more readily identifiable to a user by touch.

In some embodiments, a method of executing the present invention is completed after steps 310 and 320, indicating to a user a proper orientation of the card by actuating one or more tactile elements 122 to indicate that the thumb or finger is in contact with the feedback element 120. In some embodiments, the method may continue to step 330 after step 320. In some embodiments, it may begin at step 330 without performing the functions recited in steps 310 and 320. At step 330, the feedback processor 210 may receive a signal indicative of the presence of a merchant device proximate to the transaction card 110. This signal may be indicative of an antenna 230 of the transaction card in proximity to the merchant device, an EMV chip 130 in proximity to or inserted into a merchant device, or a magnetic strip 150 in proximity to or inserted into a merchant device. The signal may additionally or alternatively be indicative of the completion of a transaction at the merchant device. At step 340, upon receipt of the signal from one or more of the EMV chip 130, magnetic strip 150, or antenna 230, the feedback processor 210 transmits a signal to drive or actuate one or more tactile elements 122 of feedback element 120 to indicate to the user that the merchant device is proximate to the transaction card 110.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. In the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above-disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A transaction card, comprising:
a card body comprising a top surface and a bottom surface opposite the top surface;
a chip secured to the top surface of the card body and configured to communicate wirelessly;
a feedback element secured to the card body and including one or more tactile elements and a feedback sensor; and
a feedback processor in communication with the chip and the feedback element;
wherein the feedback processor, in response to receiving a signal from the feedback sensor indicative of the presence of a thumb or finger of a user on the feedback element and in response to receiving a signal from the chip, drives one or more of the one or more tactile elements to generate tactile feedback for the user.

2. The transaction card of claim 1, wherein the one or more tactile elements are integrated linear resonant actuators (LRAs) that move a mass in a reciprocal manner by means of a magnetic coil.

3. The transaction card of claim 1, wherein the one or more tactile elements are piezoelectric elements.

4. The transaction card of claim 1, wherein the one or more tactile elements comprise one or more tactile element surfaces that are substantially flush with the top surface of the card body.

5. The transaction card of claim 1, wherein a power source is embedded in the card body and powers the feedback sensor and the feedback element.

6. The transaction card of claim 1, wherein the feedback sensor is a resistive feedback sensor.

7. The transaction card of claim 1, wherein the feedback sensor is a capacitive feedback sensor.

8. A transaction card, comprising:
a card body;
a feedback element secured to the card body and including one or more tactile elements and a feedback sensor; and
a feedback processor in communication with the feedback element;
wherein the feedback processor, in response to receiving a signal from the feedback sensor, drives one or more of the one or more tactile elements to generate a vibratory tactile feedback indicating to a user an orientation of the transaction card.

9. The transaction card of claim 8, wherein the signal from the feedback sensor is indicative of the presence of a thumb or finger of a user on the feedback element.

10. The transaction card of claim 8, wherein the signal from the feedback sensor is indicative of the presence of a merchant device proximate to the feedback element.

11. The transaction card of claim 8, wherein the one or more tactile elements are integrated linear resonant actuators (LRAs) that move a mass in a reciprocal manner by means of a magnetic coil.

12. The transaction card of claim 8, wherein the one or more tactile elements are piezoelectric elements.

13. The transaction card of claim 8, wherein the one or more tactile elements comprise one or more tactile element surfaces that are substantially flush with a top surface of the card body.

14. The transaction card of claim 8, wherein a power source is embedded in the card body and powers the feedback processor and feedback element.

15. The transaction card of claim 8, wherein the feedback sensor is a resistive feedback sensor.

16. The transaction card of claim 8, wherein the feedback sensor is a capacitive feedback sensor.

17. A method, the method comprising:
receiving, at a feedback processor, a signal indicative of the presence of a thumb or finger of a user on a feedback sensor of a feedback element positioned on a transaction card; and
transmitting, from the feedback processor, a signal to actuate one or more tactile elements of the feedback element to indicate to the user that the thumb or finger is in contact with the feedback element.

18. The method of claim 17, further comprising:
receiving, at the feedback processor, a signal indicative of the presence of a merchant device proximate to the transaction card; and
transmitting, from the feedback processor, a signal to actuate one or more tactile elements of the feedback element to indicate to the user that the merchant device is proximate to the transaction card.

19. The method of claim 17, wherein the one or more tactile elements generate a vibratory tactile feedback when actuated by the feedback processor.

20. The method of claim 17, wherein the one or more tactile elements are integrated linear resonant actuators (LRAs) that move a mass in a reciprocal manner by means of a magnetic coil.
